(19) United States
(12) Patent Application Publication
(10) Pub. No.: US 2007/0291382 A1
(43) Pub. Date: Dec. 20, 2007

(54) Mirror mounting structures and methods employing shape memory materials for limited rotation motors and scanners

(76) Inventors: Adam I. Pinard, Carlisle, MA (US); Kristopher Pruyn, Tyngsborough, MA (US); Pavel Otavsky, Nashua, NH (US)

Correspondence Address: GAUTHIER & CONNORS, LLP, 225 FRANKLIN STREET, SUITE 2300, BOSTON, MA, 02110, US

(21) Appl. No.: 11/454,436

(22) Filed: Jun. 16, 2006

(51) Int. Cl. G02B 7/182

(52) U.S. Cl. 359/871

(57) ABSTRACT

A mirror mounting assembly is disclosed for use in a limited rotation motor system. The mirror mounting assembly includes a collar formed of a shape memory material and a mounting unit including a tapered base that couples with a tapered output shaft of a limited rotation motor under a radial force applied by the collar.

### BACKGROUND

The invention relates to limited rotation motors such as galvanometers, and particularly relates to limited rotation motors used to drive optical elements such as mirrors for the purpose of guiding light beams in scanners.

Limited rotation motors generally include stepper motors and constant velocity motors. Certain stepper motors are well suited for applications requiring high speed and high duty cycle sawtooth scanning at large scan angles. For example, U.S. Pat. No. 6,275,319 discloses an optical scanning device for raster scanning applications.

Limited rotation motors for certain applications, however, require the rotor to move between two positions with a precise and constant velocity rather than by stepping and settling in a sawtooth fashion. Such applications require that the time needed to reach the constant velocity be as short as possible and that the amount of error in the achieved velocity be as small as possible. Constant velocity motors generally provide a higher torque constant and typically include a rotor and drive circuitry for causing the rotor to rotate about a central axis, as well as a position transducer, e.g., a tachometer or a position sensor, and a feedback circuit coupled to the transducer that permits the rotor to be driven by the drive circuitry responsive to an input signal and a feedback signal. For example, U.S. Pat. No. 5,424,632 discloses a conventional two-pole limited rotation motor.

A requirement of a desired limited rotation motor for certain applications is a system that is capable of changing the angular position of a load such as a mirror from angle A to angle B, with angles A and B both within the range of angular motion of the scanner, and both defined arbitrarily precisely, in an arbitrarily short time while maintaining a desired linearity of velocity within an arbitrarily small error. Both the minimum time of response of this system and the minimum velocity error are dominated by the effective operating bandwidth of the system.

Such limited rotation motors may be used for example, in a variety of laser scanning applications, such as high speed surface metrology. Further laser processing applications include laser welding (for example high speed spot welding), surface treatment, cutting, drilling, marking, trimming, laser repair, rapid prototyping, forming microstructures, or forming dense arrays of nanostructures on various materials.

The processing speeds of such systems are typically limited by one of more of mirror speed, X-Y stage speed, material interaction and material thermal time constants, the layout of target material and regions to be processed, and software performance. Generally, in applications where one or more mirror speed, position accuracy, and settling time are factors which limit performance, any significant improvement in scanning system bandwidth may translate into immediate throughput improvements.

It is also generally desirable to provide load mounting structures for a shaft of a limited rotation motor without adversely affecting either the inertia of the rotor shaft and load, or adversely affecting the bonding of the shaft to the load. For example, when mounting a mirror to a limited rotation motor shaft, it is desirable to effect a secure bond without significantly increasing the inertia of the assembly. The desirability to provide a removable mounting structure so that a mirror on a shaft could be replaced imposes further demands on the relationship between bond strength and inertial mass.

There is a need, therefore, for an improved limited rotation motor system, and more particularly, there is a need for a rotor for a limited rotation motor that provides improved operating bandwidth.

### SUMMARY

In accordance with an embodiment, the invention provides a mirror mounting assembly for use in a limited rotation motor system. The mirror mounting assembly includes a collar formed of a shape memory material and a mounting unit including a tapered base that couples with a tapered output shaft of a limited rotation motor under a radial force applied by the collar.

In accordance with further embodiments, the collar surrounds at least a portion of a tapered opening in the output shaft, and in further embodiments, the collar is formed of an alloy including nickel and titanium.

In accordance with further embodiments, the invention provides a method of removing an optical element from a limited rotation motor shaft. The method includes the steps of applying a coolant material to a collar formed of a shape memory alloy to cause the shape memory material to change to a martensitic state, and removing the collar from the limited rotation motor shaft. In accordance with further embodiments, the method includes the step of applying a collar removal tool to the collar on the shaft to facilitate application of the coolant material to the collar.

### BRIEF DESCRIPTION OF THE DRAWINGS

The following description may be further understood with reference to the accompanying drawings in which:

FIG. 1 shows an illustrative diagrammatic view of a mirror and rotor assembly for a limited rotation motor system in accordance with an embodiment of the invention;

FIG. 2 shows an illustrative diagrammatic side sectional view of the mirror and rotor assembly shown in FIG. 1 taken along line 2-2 thereof;

FIG. 3 shows a portion of the illustrative diagrammatic side section view of FIG. 2 on an enlarged scale;

FIG. 4 shows a portion of a side sectional view similar to that shown in FIG. 3 of a mirror and rotor assembly for use in a limited rotation motor system in accordance with a further embodiment of the invention;

FIG. 5 shows an illustrative isometric exploded view of certain elements of a mirror and rotor assembly in accordance with a further embodiment of the invention;

FIG. 6 shows an illustrative graphical representation of a diameter versus temperature for a mirror mounting structure in accordance with an embodiment of the invention;

FIG. 7 shows an illustrative diagrammatic isometric view of a limited rotation motor system in accordance with an embodiment of the invention;

FIGS. 8 and 9 show illustrative diagrammatic side sectional views of further limited rotation motor systems of further embodiments of the invention; and

FIG. 10 and 11 shows a perspective view of an assembly/disassembly tool for use with a mirror and rotor assembly.

The drawings are shown for illustrative purposes only.

### DETAILED DESCRIPTION OF THE ILLUSTRATED EMBODIMENTS

Optical scanning applications typically require that a mirror be attached to a shaft of a motor either directly or indirectly. For example, clamp-like parts have been employed that function to support the mirror as well as to attach it to the shaft. Inseparable cradle-and-clamp designs that are built into or onto the mirror have also been employed. In some cases, the mirror is cemented into a transverse slot in the shaft or a mounting structure.

Although it is generally desirable to minimize mass and therefore inertia of a rotor and load assembly in a limited rotation motor system, applicant has discovered that a shape memory alloy may be used to provide effective removable fastening of a load onto a shaft without adversely affecting inertia in accordance with certain embodiments of the invention. Shape memory alloys, such as nickel titanium alloys (sometimes referred to as Nitinol after their discovery by the Naval Ordnance Laboratory in 1962), are known to provide changes in shape that are dependent on temperature. In general, such alloys may include for example, nickel titanium, nickel titanium niobium, nickel titanium iron, nickel aluminum, indium titanium, copper zinc, copper tin, copper aluminum nickel, gold cadmium, silver cadmium, iron platinum, manganese copper, iron manganese silicon, and further alloys of the above elements and combinations. Shape memory alloys typically change up to 5% in size when heated from a martensite (cooled) condition to an austenite (heated) condition. Although shape memory materials have been used and suggested for applications in medical devices, electrical conductors, fasteners and shaft mounted components, such materials have not be used for limited rotation motors where the bond strength versus inertia tradeoff has been considered too demanding for such a fastener.

Applicant has discovered, however, that combining the use of a shape memory material with a tapered mounting structure provides limited rotation motor systems with improved bandwidth. It is generally desirable that the mirror be attached in a way that permits easy assembly and/or removal. This is necessary to ease system assembly and alignment, and also to accommodate replacement of the mirror with one of a different size or reflectivity range, or to allow replacement of a damaged mirror in situ. The mounting means must also assure proper geometrical alignment of the mirror as mounted to the shaft, at least in the direction normal to the mirror surface. It is of important that the inertia of the mount itself not compromise the performance of the system in dynamic applications, and be robust in proportion to the shock and vibrational environment of static systems.

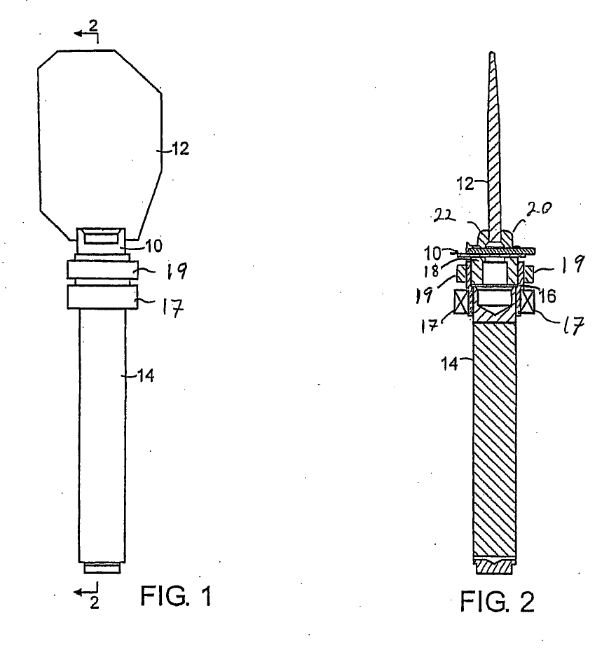

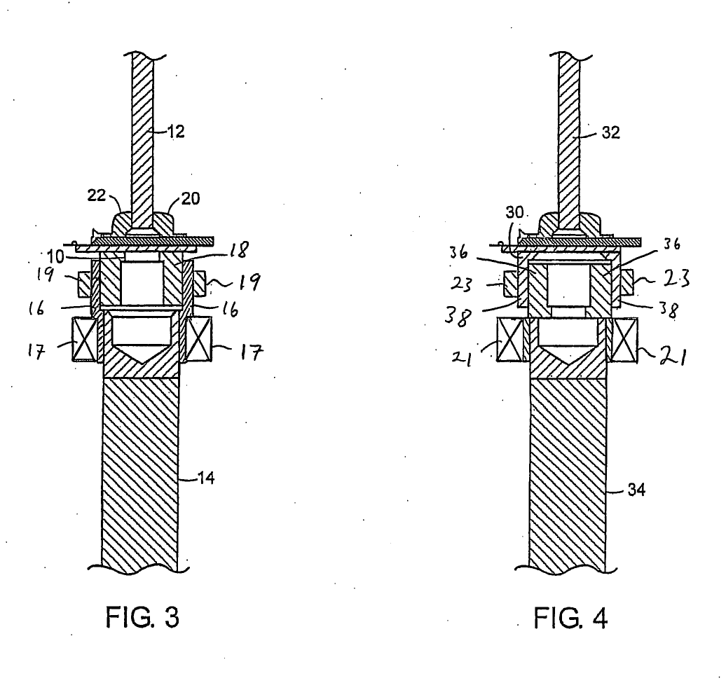

As shown in FIGS. 1-3, a collar 19 formed of a shape memory material such as a titanium nickel alloy (e.g., Ti 45% Ni 55%) and a tapered mirror mounting structure 10 may be used in accordance with an embodiment of the invention. The collar 19 may be, for example, a UniLok® product as sold by Intrinsic Devices of San Francisco, Calif. The shaft 14 may rotate about a support bearing 17. As shown in FIGS. 2 and 3, the tapered mounting structure 10 includes a transverse slot into which a mirror may be cemented, soldered or otherwise fastened, and a tapered base 18 that may be received within a tapered opening 16 in a rotor output shaft 14. The transverse slot is formed by slot elements 20 and 22 as shown in FIG. 3. The use of the collar 19 formed of a shape memory material, and the combination of the tapered coupling of the tapered base 18 of structure 10 and the tapered opening 16 provides a mounting system that is replaceable, attaches securely yet adds little inertia to the system, supports the mirror in proportion to its size, and allows a high degree of accuracy in geometrical mirror alignment.

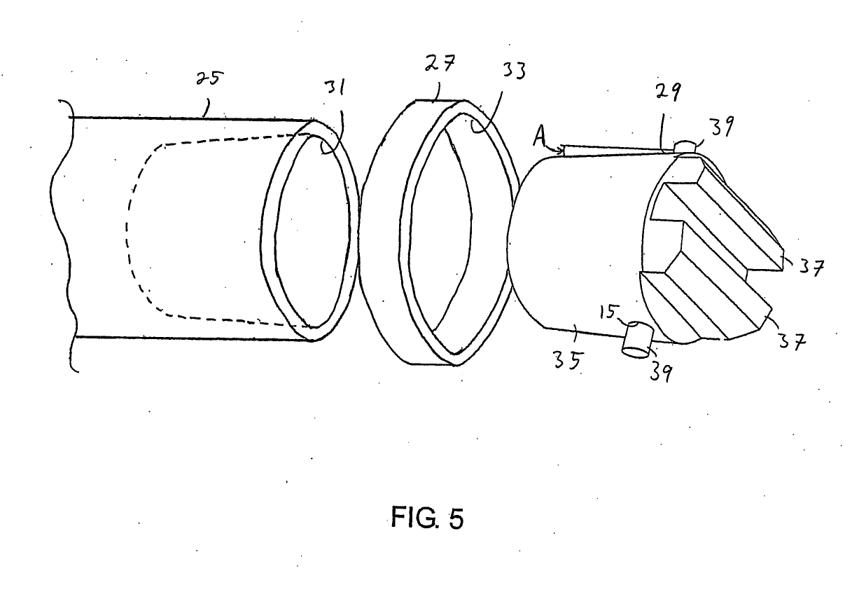

As shown in FIG. 4, in accordance with another embodiment of the invention, the mounting system may include a collar 23 of a shape memory material, and a mirror mounting structure 30 that includes a tapered opening in its base 38 that receives a tapered end 36 of a rotor output shaft 34. The structure 30 also includes a transverse slot into which a mirror 32 is cemented, soldered or otherwise secured. The shaft 34 may rotate about a support bearing 21. In each embodiment, the mirror end of the coupling unit is of a diameter, and therefore the length of the sides of the slot supporting the mirror are of a length, proportionate to the supporting rigidity, required for that particular mirror size and design. The mirror end of the coupling unit may be modified from a cylindrical form into an ellipse or other shape as required to provide a desired length of support for the mirror. The depth of the slot may also be adjusted as appropriate. The unit is tapered on the exterior at an angle, and has such a length, that it is self-locking against the motor torque in certain embodiments and is further secured by the radial force of the collar when the shape memory material is in the martensite condition.

As shown in FIG. 5, the base 35 of the mounting unit 29 includes a taper angle as indicated at A. The taper angle may for example, range from about 0.25° to about 5°, and is preferably between about 0.75° to about 3.0°, and may more preferably be from about 1.0° to about 2.0°. The mounting unit 29 is inserted into the tapered opening 31 of the shaft 25. The shape memory alloy collar 27 has an inner diameter as indicated at 33 in the austenite phase that is greater than the outer diameter of the shaft 25. When the collar 27 is in the martensite state, the inner diameter of the collar 27 as indicated at 33 is slightly smaller than the outer diameter of the shaft 25. The mounting unit 30 may also include a small hole 15 on one or both sides through which one or two rotation stops 39 may be placed in certain embodiments. The rotation stops 39 may be formed by two ends of a single pin that passes through the structure 29, or may be formed as two separate stops. In other embodiments, the mounting unit 29 maybe formed integral with a mirror or other optical element. The taper may be linear as shown in FIG. 5, or in further embodiments the taper may be non-linear.

Different applications may require different degrees of locking of the taper versus the collar. For example, it might be desired that the direction perpendicular to the face of the mirror be hand-re-adjustable with respect to the angular position of the shaft during assembly and alignment of the optical system of which it is a part prior to heating of the collar to room temperature. This application would result in a relatively large taper angle. If the application, on the other hand, required that the optical system of which it is a part must withstand large accelerations, such as those during launch of a space vehicle, a relatively small taper angle may be used.

The angle of taper and length of engagement are chosen over a range of angles and lengths as a compromise between the need for a self-locking fit, and the desire for easy release when required. The size and materials for the shape memory alloy may then be chosen to provide only the additional needed force to maintain the desired bond strength. A preferred range of useful angles for locking is between 0.03 and 0.07 inches per inch (between about 0.9° to about 2.1°). Tapers at the smaller-taper end of the range tend to grip very tightly, and at the upper end to release easily. It is also within the scope of the invention to design the taper angle and engagement length so that the tapers lock so tightly as to become essentially permanently affixed with a minor amount of force applied by the collar, and, conversely, to release so easily that they must be tightly fastened together using the shape memory collar to transmit significant torque.

In order to maximize the stiffness and minimize the inertia of the assembly, the plug and recess preferably occupy volume inside the bearing that supports the output. It is, however, within the scope of the invention that the unit and it's mating shaft portion be positioned anywhere along the shaft axis.

The inner diameter of the collar may be removed from the shaft by cooling the collar to a temperature that cause the shape memory material to enter the martensite phase, for example, by application of liquid nitrogen to the collar.

The end of the shaft or post is equipped with a concentric hollow recess in the embodiment of FIG. 3 in the form of a mating taper, so that when the base 18 in the form of a male plug is inserted into the recess and forced together into position, the tapers lock. Such a joint has optimum performance in terms of concentricity, lack of tilt, torque transmission, and freedom from a tendency to loosen in use. When it is desired to remove the mount, the collar 19 is cooled to its martensite condition and slid from the output shaft. A plier-like tool may then be clamped to the flats on the plug, and an axial tensile force of a few pounds, depending on the size of the mount and the design of the taper, is applied between the plier and the inner ring of the front bearing, in the case of a motor, or galvanometer, or a suitable flange in the case of a mounting post (not shown), thus releasing the taper without damage.

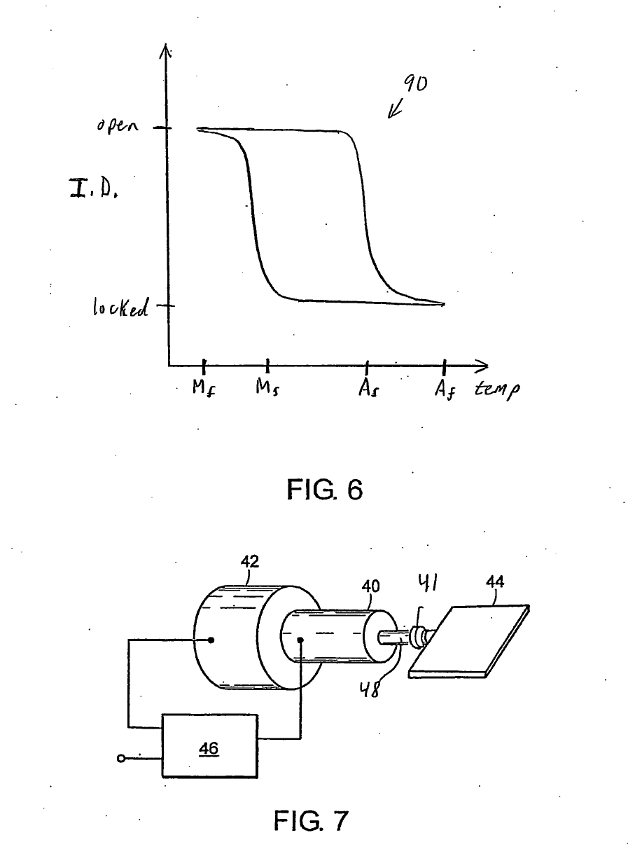

As shown at 90 in FIG. 6, the collar will open when cooled below the martensitic start (Mₛ) temperature and will reach its largest diameter when cooled to the martensitic finish (MA) temperature. The collar may then be slid over the end of the output shaft while the tapered base of the mirror mounting unit is attached to the output shaft. The collar is then permitted to warm up to room temperature and begins to reduce its diameter to its memory diameter at the austenitic start (Aₛ) temperature and reaches its smallest diameter (and therefore provides the greatest applied radial force) and the austenitic finish (A_{f}) temperature. The austenitic start and finish temperatures may, for example be 40° C. and 105° C., while the martensitic start and finish temperatures may be −50° C. and −80° C. The collar may be cooled through application of Nitrogen, CO₂ or other refrigerant. In other embodiments, the collar may also be cut and replaced. The hysteresis relationship between the temperature and inner diameter of the collar is shown in FIG. 6 and may be repeated without damage to the collar or reduction in the applied force in the locked condition.

As shown in FIG. 7, a scanner assembly including a rotor shaft and mirror mounting structure in accordance with an embodiment of the invention may include a scanner motor 40, having a rotatable rotor with an outer shaft 48 as discussed above and a shape memory alloy collar 41 that couples a mounting unit with a scanning element such as a mirror 44 onto the shaft. The scanner assembly also includes a transducer 42 attached to one end of the rotor for monitoring the position of the shaft. In other embodiments, the scanning element 44 and the position transducer 42 may each be attached to the rotor at the same end of the shaft. The system also includes a feedback control system 46 that is coupled to the transducer 42 and the motor 40 as shown to control the speed and/or position of the motor.

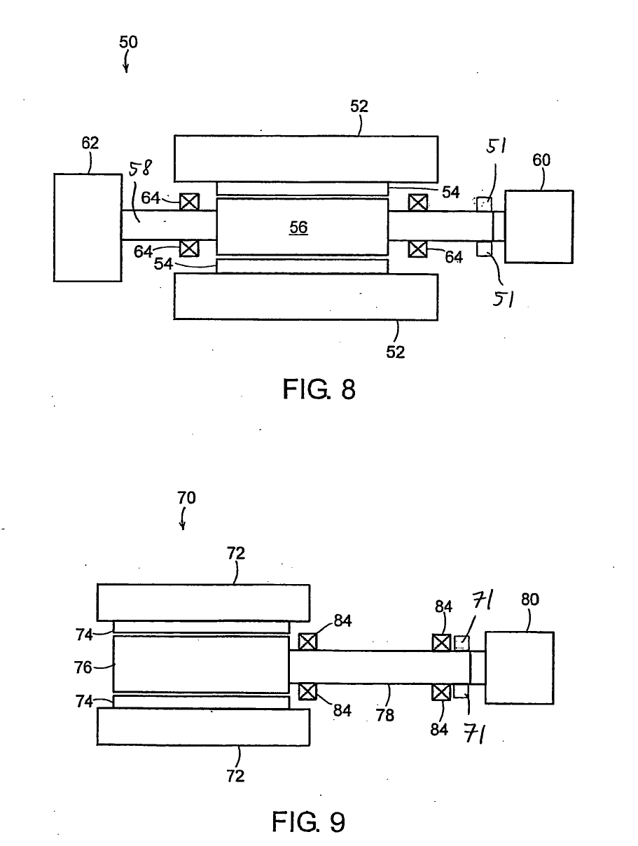

As shown in FIG. 8, a mirror mounting assembly in accordance with another embodiment of the invention may be used with in a system 50 that includes a backiron 52, stator coils 54 and a magnet 56 that is secured to a shaft 58. The shaft 58 is rotatably mounted to a housing structure (not shown) via bearings 64, and includes a shape memory alloy collar 51 that couples a mounting unit having a tapered base to the shaft. A scanner element such as a mirror 60 is attached to the mounting unit and is thereby coupled to the shaft. A position transducer 62 is mounted to the other end of the shaft 58.

As shown in FIG. 9, a limited rotation torque motor assembly 70 in accordance with a further embodiment of the invention may include a backiron 72, stator coils 74 and a magnet 76 that is secured to a shaft 78 as discussed above. A mirror 80 is attached to the shaft via a tapered mirror mounting structure and shape memory alloy collar 71 of the invention, and the shaft is rotatably secured to a housing structure (not shown) via bearings 84. The assembly 70 may further include a position transducer as discussed above.

For example, such limited rotation motors may be used in a laser drilling system for producing vias (or holes) in printed circuit boards (PCBs). The system may include a pair of galvanometer based X-Y scanners as well as an X-Y stage for transporting the PCB, and a scan lens that provides for parallel processing of circuit board regions within the field covered by the scanners and lens. The X-Y stage transports the circuit board along rows and columns needed for entire coverage. The circuit board is typically substantially larger than the scan field.

Such limited rotation motors may also be used in multi-layer drilling systems in accordance with another embodiment of the invention. The operations may include hole punching (or percussion drilling) where one or more laser pulses form a single hole within an effective spot diameter without relative movement of the beam with respect to object, or may include trepanning (which does involve relative movement between the beam and the object during the drilling operation). During trepanning, a hole having a diameter substantially larger than a spot diameter is formed. A substrate is laser drilled from a top surface of the substrate to an exposed bottom surface of the substrate using a plurality of laser pulses that are preferably trepanned in a circle, but other trepanning patterns, such as ovals and squares, may be used. For example, a trepanning pattern of movement of the laser focal spot is one in which the beam spot starts in the center of the desired via, and gradually spirals outwardly to an outer diameter of the via. At that point the beam is caused to orbit around the via center for as many revolutions as is determined necessary for the particular via. Upon completion, the focal spot is caused to spiral back to the center and thereafter awaits the next command. An example of a trepanning velocity is 3 millimeters per second. In such drilling applications, it is sometimes advantageous to provide rapid point to point positioning of the beam with a rapid settling time irrespective of the trajectory between the points.

The overall drilling system throughput can be affected by many factors such as the required number of holes within a field, hole size, stage speed, etc. System bandwidth improvements may be generally useful within a substrate drilling system, and such improvements may be particularly advantageous in substrate drilling systems wherein trepanning or similar motion is used for hole formation. Limited rotation motors discussed above may also be employed for drilling other substrates such as electronic packages, semiconductor substrates, and similar workpieces.

Such limited rotation motors may also be employed in substrate marking employing lasers, or laser marking, of for example, semiconductors, wafers and the like on either front or backsides of the substrates. The marks produced by the laser (such as a diode pumped solid state laser), whether on a front or back side, may be formed as a 1D or 2D matrix, and in compliance with various industry standards. The performance of such a system may depend, at least in part, on marking speed, density, and quality, and improvements in limited rotation motor performance may improve marking speed, density and quality. Marking speed over a field, as measured in mm/sec for example, is a function of the laser repetition rate, spot size, and the speeds of the one or motors (e.g., low and fast scan direction motors) used in the system.

In accordance with further embodiments, systems of the invention may be provided for other high speed marking applications in the electronic industry such as, for example, marking of packages or devices in trays, or other similar workpieces.

Limited rotation motors as discussed above may also be employed in laser trimming systems in accordance with further embodiments of the invention. One or more embodiments of the present invention may be used in a laser trimming system, or in a substrate micromachining system. For example, such a system may provide a method for high-speed, precise micromachining an array of devices (such as resistors), with each of the devices having at least one measurable property (such as resistance). The method includes the steps of: a) selectively micromachining a device in the array to vary a value of a measurable property; b) suspending the step of selectively micromachining; c) while the step of selectively micromachining is suspended, selectively micromachining at least one other device in the array to vary a value of a measurable property; and d) resuming the suspended step of selectively micromachining to vary a measurable property of the device until its value is within a desired range. At least one of the steps of selectively micromachining may include the steps of generating and relatively positioning a laser beam to travel in a first scanning pattern across the devices, superimposing a second scanning pattern with the first scanning pattern and irradiating at least one device with at least one laser pulse.

A micromachining system in accordance with another embodiment of the invention may provide for a fast scan pattern to be carried out using with an acousto-optic deflector, superimposed on a second, lower speed scan pattern that is carried out using a limited rotation motor as discussed above. Generally, the access or retrace time of the acousto-optic deflector is on the order of tens of microseconds. In certain embodiments improved motor speed will directly result in improved trimming speed.

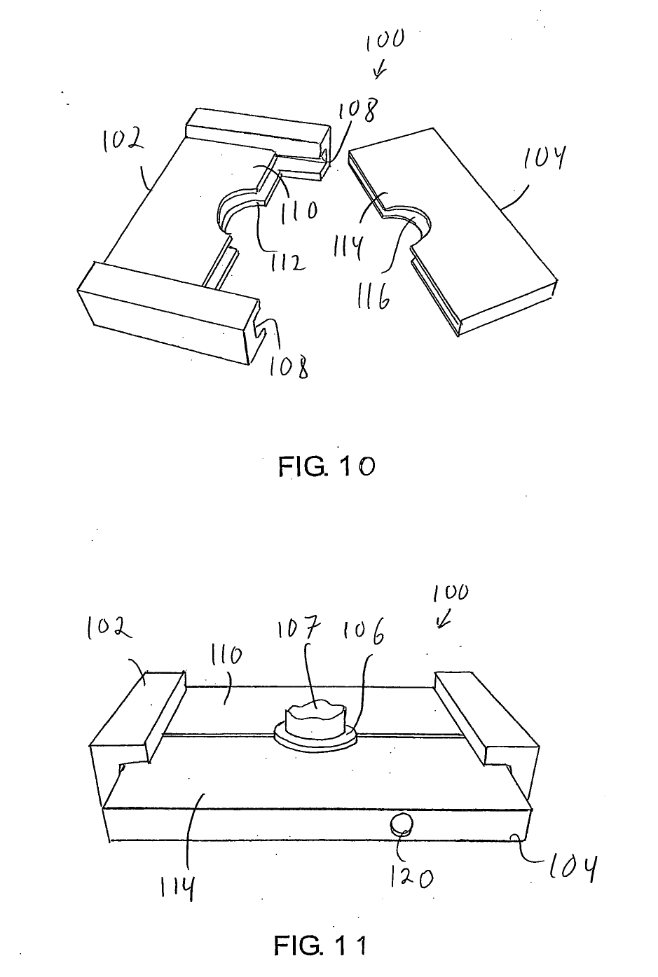

In accordance with further embodiments of the invention, mirrors and other optical elements may be easily and readily mounted to and removed from limited rotation motor shafts using a mirror mounting system of the invention. For example, as shown in FIGS. 10 and 11, a tool 100 including a first part 102 and a second part 104 may be employed for removing a clamp ring 106 from a limited rotation motor shaft 107. The first part 102 of the tool 100 includes an opening 108 between an upper panel 110 and lower panel 112, and the second part 104 of the tool 100 includes an opening between an upper panel 114 and a lower panel 116. When the second part 104 is received within the first part 102, an enclosed cavity is formed around the collar 106. This cavity may be accessed via an opening 120 that may optionally include a fluid coupling. A coolant such as liquid nitrogen may be introduced into the opening 120 to permit the collar 106 to become cooled to its martensitic finish state without requiring that a person directly contact the collar 106. The tool 100 may also act to hold the loosened collar 106 while it is being removed from the shaft 107.

The use of such a collar and removal tool significantly facilitates removal and replacement of optical elements in remote field locations since only the tool, coolant fluid and a replacement collar need to be present at the remote location.

Those skilled in the art will appreciate that numerous modifications and variations may be made to the above disclosed embodiments without departing from the spirit and scope of the invention.

What is claimed is:

1. A mirror mounting assembly for use in a limited rotation motor system, said mirror mounting assembly comprising a collar formed of a shape memory material and a mounting unit including a tapered base that couples with a tapered output shaft of a limited rotation motor under a radial force applied by the collar.

2. The mirror mounting assembly as claimed in claim 1, wherein said collar surrounds at least a portion of a tapered opening in the output shaft.

3. The mirror mounting assembly as claimed in claim 1, wherein said collar is formed of an alloy including nickel and titanium.

4. The mirror mounting assembly as claimed in claim 1, wherein said tapered base is a tapered male plug for engaging a female end of the output shaft.

5. The mirror mounting assembly as claimed in claim 1, wherein said tapered base is a tapered female end for engaging a male end of the output shaft.

6. The mirror mounting assembly as claimed in claim 1, wherein said tapered base includes a taper angle of between about 0.03 inches per inch and about 0.07 inches per inch.

7. The mirror mounting assembly as claimed in claim 1, wherein said mounting unit is formed of any of silicon carbide, titanium, and beryllium.

8. The mirror mounting assembly as claimed in claim 1, wherein a mirror is coupled to said mounting unit via a receiving means for receiving said mirror on said mounting unit.

9. The mirror mounting assembly as claimed in claim 1, wherein a mirror is formed integral with the mounting unit.

10. The mirror mounting assembly as claimed in claim 1, wherein said tapered base includes a taper that is linear.

11. The mirror mounting assembly as claimed in claim 1, wherein said mirror mounting assembly is coupled to a scanning system.

12. The mirror mounting assembly as claimed in claim 1, wherein said mirror mounting assembly is provided with a laser drilling system.

13. The mirror mounting assembly as claimed in claim 1, wherein said mirror mounting assembly is provided with a laser marking system.

14. The mirror mounting assembly as claimed in claim 1, wherein said mirror mounting assembly is provided with a substrate machining system.

15. The mirror mounting assembly as claimed in claim 1, wherein said mirror mounting assembly is provided with a laser trimming system.

16. A mirror mounting assembly for use in a limited rotation motor system, said mirror mounting assembly comprising receiving means for receiving a mirror, a tapered base that mates with a tapered end of an output shaft of the limited rotation motor for coupling the mirror mounting unit to the output shaft, and a collar formed of a shape memory alloy that secures the tapered base to the output shaft when in the shape memory alloy is in an austenite condition.

17. The mirror mounting assembly as claimed in claim 16, wherein said collar surrounds at least a portion of a tapered opening in the output shaft

18. The mirror mounting assembly as claimed in claim 16, wherein said collar is formed of an alloy including nickel and titanium.

19. The mirror mounting assembly as claimed in claim 16, wherein said tapered base is a tapered male plug for engaging a female end of a the output shaft.

20. The mirror mounting assembly as claimed in claim 16, wherein said tapered base includes a taper angle of between about 0.03 inches per inch and about 0.07 inches per inch.

21. The mirror mounting assembly as claimed in claim 16, wherein said mirror mounting unit is formed of any of silicon carbide, titanium, and beryllium.

22. The mirror mounting assembly as claimed in claim 16, wherein said tapered base includes a taper that is linear.

23. A mirror mounting assembly for use in a limited rotation motor system, said mirror mounting unit comprising a mirror, a tapered base for coupling the mirror mounting unit to a tapered opening in an output shaft of a limited rotation motor, and a collar formed of a shape memory alloy that surrounds the output shaft and tapered base of the mirror mounting unit.

24. The mirror mounting assembly as claimed in claim 23, wherein said mirror mounting assembly is included in an optical scanner system.

25. A mirror mounting assembly for use in a limited rotation motor system, said mirror mounting unit comprising a mirror, a base for coupling the mirror mounting unit to an opening in an output shaft of a limited rotation motor, a collar formed of a shape memory alloy that surrounds the output shaft and base of the mirror mounting unit; and a removal tool for engaging the collar while a coolant material is applied to the collar during removal.

26. The mirror mounting assembly as claimed in claim 25, wherein said removal tool includes separable portions that may be closed to engage the collar yet provide a cavity around at least a portion of the collar that may be contacted with the coolant material.

27. A method of removing an optical element from a limited rotation motor shaft, said method comprising the steps of applying a coolant material to a collar formed of a shape memory alloy to cause the shape memory material to change to a martensitic state, and removing said collar from the limited rotation motor shaft.

28. The method as claimed in claim 27, wherein said method further includes the step of applying a removal tool to said collar to faciliate the application of the coolant material to the shape memory material.

29. A method of removing an optical element from a limited rotation motor shaft, said method comprising the steps of providing a collar formed of a shape memory alloy as a fastener for coupling the optical element to the limited rotation motor shaft, and providing a coolant material that may be applied to the collar to cause the shape memory material to change to a martensitic state thereby facilitating removal of said collar from the limited rotation motor shaft.
